(19) United States
(12) Patent Application Publication
(10) Pub. No.: US 2025/0200332 A1
(43) Pub. Date: Jun. 19, 2025

(54) PROCESSING CONVERSATION RECORDS USING LANGUAGE MODELS FOR KNOWLEDGE BASE ENRICHMENT

(71) Applicant: INTERCOM, INC., San Francisco, CA (US)

(72) Inventors: Pedro TABACOF, Dublin (IE); Fergal Charles REID, Dublin (IE); Molly Cullen MAHAR, Haarlem (NL)

(21) Appl. No.: 18/539,158

(22) Filed: Dec. 13, 2023

(51) Int. Cl. G06N 3/0455; G06F 40/35; G06N 3/006; G06Q 30/015

(52) U.S. Cl. CPC G06N 3/0455; G06F 40/35; G06N 3/006; G06Q 30/015

(57) ABSTRACT

Technology is disclosed for programmatically controlling a language model to extract aspects of conversations. In one implementation, a conversation is accessed from a communication record between a user and support agent. A first prompt is generated for a language model with the communication record and a request to the language model to extract each of a set of questions and answer (“Q&A”) pairs from the communication record and provide contextual metadata corresponding to each Q&A pair. A second prompt is generated for the language model with a request to the language model to filter irrelevant Q&A pairs based on the contextual metadata of each Q&A pair and generate a single, summarized Q&A pair based on each remaining Q&A pair. An embedding corresponding to at least a portion of the single, summarized Q&A pair is generated, and may be utilized for knowledge base enrichment or for deploying an improved chatbot.

### BACKGROUND

Modem chatbots for customer support require a knowledge base, which generally includes articles located in a help center that are human crafted and curated. However, most volume of customer support, as measured by words, are stored in conversations between customer and customer support agents, not in help centers. Conversational customer support data can often be more helpful for a customer and include information not available in the knowledge base as the customer support representative must manually provide an answer to the customer's question or problem.

### SUMMARY

Various aspects of the technology described herein are generally directed to systems, methods, and computer storage media for, among other things, programmatically controlling a language model to determine aspects of conversations, and using the aspects for knowledge base enrichment or for providing improved chatbots. In this regard, embodiments described herein facilitate using a language model to identify or extract aspects of a conversation in order to enrich (or create) a knowledge base utilized by a chatbot to retrieve answers to queries from customers and/or a web page directed to frequently asked questions (FAQs) from customers. For example, aspects of a conversation corresponding to question and answer (Q&A) pairs occurring within the conversation can be programmatically identified and extracted from conversations between a customer (e.g., or potential customer or any individual providing questions to customer support) and a customer support agent (“CSA”) (e.g., or any support personnel). The aspects of the conversation, referred to herein as conversational snippets, can be added to a help center database and/or a vector database so that a chatbot can utilize the Q&A snippets to provide automated customer support. In some embodiments, in order to identify the most relevant Q&A snippets from conversations between a customer and a CSA, a first call is made to a language model to extract all of the Q&A pairs from a conversation and annotate the Q&A pairs. A second call is made to the language model to remove irrelevant Q&A pairs of the conversation and generate a single, summarized Q&A pair from the remaining Q&A pairs of the conversation. In one implementation, the single, summarized Q&A pair of the conversation is presented to an end user, such as an administrator or the CSA, for approval before storage in a content management system and/or a vector database. In another implementation, the summarized Q&A pair is automatically stored when certain criteria are met, such as a frequency of similar Q&A pairs determined from chats involving the CSA or other support personnel.

In some embodiments, the summarized Q&A pair can be presented in an FAQ web page or utilized by a chatbot to generate answers to semantically similar questions in the future. For example, an answer from a Q&A pair may be automatically provided via a chatbot in response to a customer asking a question that is semantically similar to the question in the Q&A pair. Similarly, the answer from the Q&A pair may be provided to the CSA in response to the customer asking a question that is semantically similar to the question of the Q&A pair. In this way, the CSA can read and interpret the answer for the customer or provide the answer from the Q&A pair to the customer. Further, in some implementations, a plurality of answers from a plurality of Q&A pairs, each having a question similar to a question asked by the customer, may be automatically determined and provided to the CSA or the customer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an example computing system in which one or more embodiments of the present disclosure can be practiced, in accordance with various embodiments of the present disclosure.

FIG. 2 depicts an example diagram of a model implemented to extract and summarize a conversational snippet from a communication record, in accordance with various embodiments of the present disclosure.

FIG. 3A provides an example interface for adding a conversational snippet from a communication record to a knowledge base, in accordance with embodiments of the present disclosure.

FIG. 3B provides an example interface for implementing the extraction of conversational snippets from a communication record, in accordance with embodiments of the present disclosure.

FIG. 3C provides an example interface providing content suggestions corresponding to conversational snippets extracted from communication records, in accordance with embodiments of the present disclosure.

FIG. 3D provides an example interface for suggesting or not suggesting the addition of the conversational snippets to a knowledge base, in accordance with embodiments of the present disclosure.

FIG. 3E provides an example interface providing a listing of conversational snippets extracted and added to the knowledge base, in accordance with embodiments of the present disclosure.

FIG. 3F-G provides example interfaces for a customer device of a conversation between a customer and a chatbot where the answer generated by the chatbot utilizes a conversational snippet stored in a knowledge base, in accordance with embodiments of the present disclosure.

FIG. 3H-I provides example interfaces for a customer support device of a conversation between a customer and a chatbot where the answer generated by the chatbot utilizes a conversational snippet stored in a knowledge base, in accordance with embodiments of the present disclosure.

FIG. 4 is a flow diagram showing a method for using a language model to extract conversational snippets, in accordance with embodiments of the present disclosure.

FIG. 5 is a flow diagram showing a method for generating an answer to a customer query based on a conversational snippet extracted by a language model, in accordance with embodiments of the present disclosure.

FIG. 6 is a block diagram of an example computing device in which embodiments of the present disclosure can be employed.

### DETAILED DESCRIPTION

Modem chatbots for customer support require a knowledge base, which generally includes articles located in a help center that are human crafted and curated. However, most volume of customer support, as measured by words, are stored in conversations between customer and customer support agents, not in help centers. Conversational customer support data can often be more helpful for a customer and include information not available in the knowledge base as the customer support representative must manually provide an answer to the customer's question or problem.

Currently, in order to add information manually provided by a customer support representative to the knowledge base, the conversational data between the customer support representative and the customer must be manually analyzed and edited by a human in order to manually add any additional information to the knowledge base. Accordingly, unnecessary computing resources are utilized during the manually intensive process in conventional implementations requiring manual human analysis of each conversation, manual drafting and editing of possible information to add to the knowledge base, and manual adding of the information to the knowledge base. For example, the increase in the number of computer input/output operations related to manual human analysis of each conversation, drafting, editing and/or adding of information to the knowledge base is computationally intensive and unnecessarily consumes computing resources. Similarly, when the information is located over a network, network resources are unnecessarily consumed thereby decreasing throughput, increasing latency, and increasing packet generation costs.

As such, embodiments of the present disclosure are directed to using a language model to extract conversational snippets in an efficient and effective manner. In this regard, conversational snippets extracted from conversational data by a language model can be efficiently and effectively utilized to enrich or create a knowledge base utilized by a chatbot to retrieve answers to queries from customer and/or a web page directed to frequently asked questions (FAQs) from customers.

Generally, and at a high level, embodiments described herein facilitate using a language model to extract conversational snippets. For example, conversational snippets corresponding to question and answer (“Q&A”) pairs can be extracted from conversations between a customer (e.g., or potential customer or any individual providing questions to customer support) and a customer support agent (“CSA”) (e.g., or any support personnel). The conversational snippets can be added to a help center database and/or a vector database so that a chatbot can utilize the Q&A snippets to provide automated customer support. In some embodiments, in order to identify the most relevant Q&A snippets from conversations between a customer and a CSA, a first call is made to a language model to extract all of the Q&A pairs from a conversation and annotate the Q&A pairs. A second call is made to the language model to remove irrelevant Q&A pairs of the conversation and generate a single, summarized Q&A pair from the remaining Q&A pairs of the conversation. In one implementation, the single, summarized Q&A pair of the conversation is presented to an end user, such as an administrator or the CSA, for approval before storage in a content management system and/or a vector database. In another implementation, the summarized Q&A pair is automatically stored when certain criteria are met, such as a frequency of similar Q&A pairs determined from chats involving the CSA or other support personnel.

In some embodiments, the summarized Q&A pair can be presented in an FAQ web page or utilized by a chatbot to generate answers to semantically similar questions in the future. For example, an answer from a Q&A pair may be automatically provided via a chatbot in response to a customer asking a question that is semantically similar to the question in the Q&A pair. Similarly, the answer from the Q&A pair may be provided to the CSA in response to the customer asking a question that is semantically similar to the question of the Q&A pair. In this way, the CSA can read and interpret the answer for the customer or provide the answer from the Q&A pair to the customer. Further, in some implementations, a plurality of answers from a plurality of Q&A pairs, each having a question similar to a question asked by the customer, may be automatically determined and provided to the CSA or the customer.

In operation, as described herein, a conversation is accessed from a communication record. For example, the communication record may comprise a chat log, chat transcript, meeting transcript, email, or other communication between a customer and a CSA. For example, a customer initiates a chat with a CSA through a chat interface. During the chat, the customer asks the CSA a series of questions and the CSA provides answers to each question before the chat is ended. After the chat ends, the chat is stored so that the chat can be accessed in order to extract each question and corresponding answer (e.g., the Q&A pairs) from the chat in a subsequent step. In some embodiments, the conversation can be accessed from the communication record during the conversation (e.g., chat) between the customer and the CSA in order to extract Q&A pairs from the conversation during the conversation.

In some embodiments, Q&A pairs can be detected from the communication record. For example, the conversation is analyzed to determine that the conversation has qualifying Q&A pairs and/or if the conversation meets certain criteria. The communications from the customer and corresponding responses from the CSA and/or detected Q&A pairs may be indexed in the communication record, or a portion of the conversation comprising the Q&A pair may be extracted from the communication record. In one implementation, detected Q&A pairs are indexed using a logical index wherein a corresponding pointer (or pointers) is used to reference the portion of the conversation that includes the Q&A pair.

Some implementations use live extraction to extract Q&A pairs during a conversation between a customer and a CSA and/or immediately after a conversation ends between a customer and a CSA. In these implementations, criteria, or any combination of criteria, are utilized to determine whether to extract a Q&A pair(s). In one example, the criteria can be implemented to only trigger extraction based on a threshold length of message from a CSA. For example, the CSA's message needs to be at least 10 characters long. In another example, the criteria can be implemented to only trigger extraction based on a threshold dissimilarity between answers and passages from the help center database. For example, if an answer is at least 60% similar to a help center passage using the partial Levenshtein similarity, no extraction is triggered. In another example, the criteria can be implemented to only trigger extraction for certain conversations based on a probability model. For example, the probability of the extraction of being triggered is given by the following probability model:

Threshold=Max(0.01,Min(0.99,Agent message character length/600))

If Uniform[0,1]>Threshold,run extraction,else do nothing

Other implementations batch process communication records after a certain number of conversations has occurred. In these implementations, criteria, or any combination of criteria, may be used to determine which conversations should be included in the batch processing. In one example, the criteria can be implemented to include a start date filter. For example, communication records can be batch processed to trigger extractions for conversations from a certain date. In another example, the criteria can be implemented to batch process communication records by filtering conversations which are closed, snoozed, and/or open. In another example, the criteria can be implemented to batch process communication records by removing duplicate communication records and/or Q&A pairs in batch extraction. For example, the criteria can be implemented to batch process communication records to remove duplicate Q&A pairs by using semantic or string similarity to find similar Q&A pairs and preserve just one Q&A pair. In another example, the criteria can be implemented to batch process communication records limiting the number of extractions, for example, based on the probability model:

Threshold=Max(0.01,Min(0.99,Agent message character length/600))

If Uniform[0,1]>Threshold,run extraction,else do nothing

In some embodiments, an input prompt with the indexed conversation (e.g., or portion thereof) can be generated for a language model that is trained to generate a natural language output based on an input prompt. In this regard, the input prompt includes a request to the language model (e.g., a large language model (“LLM”) such as GPT4) to extract Q&A pairs from the portion of the conversation and to generate a single, summarized Q&A pair based on the Q&A pairs extracted from the conversation. For example, the conversation included with the input prompt to the language model may be represented in a string format as follows:
Bot: [bot_message1]
User: [user_message1]
Agent: [agent_message1]
User: [user_message2]
Agent: [agent_message2]
. . .

As can be understood, “User” represents the customer followed by the customer's corresponding message(s), “Agent” represents the CSA followed by the CSA's corresponding message(s), and “Bot” represents any automated workflow or chatbot that interacts with the user before reaching the CSA followed by the bot's corresponding message(s).

In some implementations, the conversation provided to the language model is limited to a previous number of characters to prevent context overflow. For example, with respect to GPT4, the context window is 8k tokens, where English words are represented on average with 1.3 tokens. The context window also includes instructions, examples, and the completions, so the conversation needs to occupy at most a fraction of the content window. In this example, the conversation provided to the language model can be limited to its previous 5000 characters to prevent context overflow.

In some embodiments, a plurality of prompts are provided to the language model in order to extract Q&A pairs from the portion of the conversation and to generate a single, summarized Q&A pair based on the Q&A pairs extracted from the conversation. For example, an initial prompt is provided to the language model including at least a portion of the conversation containing the Q&A pairs and a request to extract the Q&A pair(s). The initial prompt (and/or a subsequent prompt) can include a request to tag each Q&A pair of the conversation with contextual metadata corresponding to each of the Q&A pairs. A subsequent prompt (and/or the initial prompt) can include a request to filter irrelevant Q&A pairs of the conversation based on the metadata of each Q&A pair (e.g., classify whether the each of the Q&A pairs should be utilized to generate the single, summarized Q&A pair). A subsequent prompt from the initial prompt can include a request to generate a single, summarized Q&A pair based on the remaining Q&A pairs (e.g., after filtering) extracted from the conversation.

In some embodiments, the input prompt, such as a single input prompt or a prompt from a plurality of prompts, to the language model can include additional instructions for the extraction of the Q&A pairs. In one example, the additional instructions to the language model for the extraction of the Q&A pairs can include instructions to preserve links or Uniform Resource Locators (“URLs”) if links or URLs are relevant to the answer. In another example, the additional instructions to the language model for the extraction of the Q&A pairs can include instructions to remove phatic expressions (e.g., expressions that convey only social information, such as “hello”, “thank you”, “got it”, and/or “you're welcome”). In another example, the additional instructions to the language model for the extraction of the Q&A pairs can include instructions to remove personal information, such as personally identifiable information (“PII”), from the Q&A pairs. In another example, the additional instructions to the language model for the extraction of the Q&A pairs can include instructions to only extract Q&A pairs that are useful to other customers.

In some embodiments, the input prompt, such as a single input prompt or a prompt from a plurality of prompts, to the language model can include instructions to tag each Q&A pair of the conversation with contextual metadata corresponding to the Q&A pair. For example, the language model can tag (or otherwise associate) each Q&A pair with contextual metadata corresponding to who provided the textual snippet, the topic of the Q&A pairs, the relevance score to other customers, and/or the type of dialog classification for the Q&A. In some embodiments, the index is tagged or otherwise associated with the contextual metadata. Examples of contextual metadata include: (1) contextual metadata corresponding to whether the question was answered by a human (e.g., a CSA) or a bot (e.g., the chatbot); (2) contextual metadata corresponding to the topic of the Q&A pair; (3) contextual metadata corresponding to a score indicating the relevance of the Q&A pair to other customers; and/or (4) contextual metadata corresponding to a dialog classification corresponding to a category of the type of dialogue. For example, categories of the type of dialogue can include: (a) informational content where an answer in the Q&A pair is directed to general information, knowledge and/or instructions; (b) a clarification where an answer in the Q&A pair is a request for clarification from the user; (c) a CSA action where an answer in the Q&A pair required the CSA to take some action on the background of the conversation; (d) a feature request where an answer in the Q&A pair is directed to future product improvements or feature requests; and/or (e) other categories or a category for an answer in the Q&A pair does not fit into the previous specified types of dialogue.

A specific example of an initial prompt to a language model with a request to extract the Q&A pair(s) and tag each Q&A pair of the conversation with contextual metadata corresponding to each of the Q&A pairs is as follows:
EXTRACT_SYSTEM_PROMPT=“″”
You're an expert customer support AI working for {app_name}. You can differentiate between informational and phatic content. You're a master at identifying personal information and PII. You always provide the answers in markdown format. Your main task is extracting questions and answers pairs from a conversation. Those Q&A pairs will be used to create a help center article that will be used by a chatbot to solve customer issues.
“″”.strip( )
EXTRACT_HUMAN_MESSAGE1=“″”
Given a conversation history between a user (User) and a customer support agent (Agent), extract all the questions asked by the user and all the answers provided by the customer support agent that have informational content. Don't include phatic expressions or responses that do not convey any meaningful information. Remove any personal or PII information, but keep relevant URLs and links. Make the questions and answers general so that they can be useful to other {app_name}customers. Never ask the customer to contact support in the answer: they are already talking to customer support. For each Q&A pair, provide a relevancy score from 0 to 10, where 0 means irrelevant for other users and 10 means relevant for any potential user. Explain the reasoning before providing the score. For each Q&A pair, classify the agent into “human” or “bot”.
For each Q&A pair, provide a dialog classification. The dialog should be one of the following categories:
   informational_content: an answer that contains general information, knowledge or instructions
   clarification: an answer that requires clarification from the user
   agent_action: an answer that required the agent to take some action on the background
   feature_request: an answer talking about future product improvements or feature requests
   other: whatever doesn't fit the previous options
For each Q&A pair, provide a topic classification. Come up with a topic that best represents the pair.
Provide the output in the following format:
User Question 1: [question] Answer 1: [answer in markdown]
Relevance Score 1: [explanation for the score]−[relevance_score] Agent 1: [human/bot]
Dialog 1: [informational_content/clarification/agent_action/feature_request/other]
Topic 1: [topic]
User Question 2: [question] Answer 2: [answer in markdown]
Relevance Score 2: [explanation for the score]−[relevance_score] Agent 2: [human/bot]
Dialog 2: [informational_content/clarification/agent_action/feature_request/other]
Topic 2: [topic]
. . .
Here is an example of conversation history:
′ ′ ′
User: Hello, I'm having trouble logging into my account.
Agent: Hi there, Brad! I'm sorry to hear that. Are you getting any error messages?User: Yes, it says my password is incorrect.
Agent: In that case, Brad, you can reset your password using the ““Forgot Password”” option on the login page. This will send an email with instructions to your registered email address. User: Thanks! I tried that, but I haven't received the email yet.
Agent: Please check your spam or junk folder, as sometimes the email can land there. If you still can't find it, let me know and I'll assist you further, Brad.
User: I found it in my spam folder. Thanks for the help!
Agent: You're welcome, Brad! If you face any more difficulties, let me know. Have a great day, bye!
′ ′ ′
Here is the expected output:
“″”.strip( )
EXTRACT_ASSISTANT_MESSAGE1=“″”
User Question 1: What should I do if I have trouble logging into my account?
Agent Answer 1: Check if you are getting any error messages. The error messages can help identify the problem.
Relevance Score 1: Relevant for all users that might be having problems logging in—9
Agent 1: human
Dialog 1: informational_content Topic 1: Account login
User Question 2: What should I do if my password is incorrect?
Agent Answer 2: You can reset your password using the ““Forgot Password”” option on the login page. This will send an email with instructions to your registered email address.
Relevance Score 2: Relevant for users that are inputting the wrong password, which seems rarer than logging in issues—7
Agent 2: human
Dialog 2: informational_content
Topic 2: Account login
User Question 3: What if I haven't received the password reset email?
Agent Answer 3: Check your spam or junk folder, as sometimes the email can land there. Relevance Score 3: Relevant for users that couldn't find the password reset email, even rarer—6
Agent 3: human
Dialog 3: informational_content Topic 3: Account login “″”.strip( )
EXTRACT_HUMAN_MESSAGE2=“″”
Here is another example of conversation history:
′ ′ ′
User: Hello, I need help!
Agent: Hey, how can I help you today?
′ ′ ′
Here is the expected output:
“″”.strip( )
EXTRACT_ASSISTANT_MESSAGE2=“″”
Nothing to extract “″”.strip( )
EXTRACT_HUMAN_MESSAGE3=“″”
Extract only the questions and answers with informational content answered by a human agent, remove any PII or personal information (except URLs and links), and generalize the content for other customers. Format the answers in markdown. If there are no questions and answers to extract, simply say “Nothing to extract”.
′ ′ ′
{conversation}
′ ′ “″”.strip( )

In some embodiments, the input prompt, such as a single input prompt or a prompt from a plurality of prompts, to the language model can include instructions to filter irrelevant Q&A pairs of the conversation based on the contextual metadata of each Q&A pair. For example, each of the Q&A pairs of the conversation can be classified as to whether each Q&A should be included in the final Q&A, such as based on the relevance of the Q&A to the conversation and any of the contextual metadata tags. In one example, the instructions to the language model may instruct the language model to filter out Q&A pairs with an answer from a bot (e.g., a chatbot) so that only Q&A pairs with human-generated answers remain (e.g., answers generated by the CSA). In another example, the instructions to the language model may instruct the language model to filter out Q&A Pairs with answers with certain dialog classifications (e.g., filter out categories of the type of dialogue corresponding to clarification, CSA action, feature request or other). In this regard, only Q&A pairs with answers classified into a dialogue classification where the answer in the Q&A pair includes informational content (e.g., directed to general information, knowledge and/or instructions) remain. In another example, the instructions to the language model may instruct the language model to filter out Q&A pairs with answers that are irrelevant to the main topic of the conversation so that only Q&A pairs relevant to the main topic of the conversation remain. In some embodiments, the instructions to filter irrelevant Q&A pairs of the conversation based on the metadata of each Q&A pair are included in a second prompt to the language model.

In some embodiments, the input prompt, such as a single input prompt or a prompt from a plurality of prompts, to the language model can include instructions to generate a single, summarized Q&A pair for the remaining Q&A pairs (e.g., after filtering). In one example, the instructions to the language model may instruct the language model to generate the single, summarized Q&A pair while preserving links (e.g., URLs) if the links are relevant to the answer of the single, summarized Q&A pair. In another example, the instructions to the language model may instruct the language model to generate the single, summarized Q&A pair while removing phatic expressions (e.g., expressions that convey only social information, such as “hello”, “thank you”, “got it”, and/or “you're welcome”) from the single, summarized Q&A pair. In another example, the instructions to the language model may instruct the language model to generate the single, summarized Q&A pair so that the single, summarized Q&A pair is useful to other customers. In another example, the instructions to the language model may instruct the language model to generate the single, summarized Q&A pair and remove any personal information (e.g., PII) from the single, summarized Q&A pair. In some embodiments, the instructions to generate a single, summarized Q&A pair for the remaining Q&A pairs (e.g., after filtering) are included in the second prompt to the language model.

A specific example of a subsequent prompt (e.g., a second prompt), following the specific example of the initial prompt above, to a language model with a request to filter irrelevant Q&A pairs of the conversation based on the metadata of each Q&A pair and generate a single, summarized Q&A pair based on the remaining Q&A pairs (e.g., after filtering) extracted from the conversation is as follows:
SUMMARIZE_SYSTEM_PROMPT=“″”
You're an expert customer support AI working for {app_name}. You can integrate multiple customer issues into one help center article. “″”.strip( )
SUMMARIZE_HUMAN_MESSAGE=“″”
You will be given a list of extracted questions and answers (Q&A) pairs from a conversation between a user and a customer support agent with this format:
′ ′ ′
User Question 1: [question]
Answer 1: [answer in markdown]
Relevance Score 1: [explanation for the score]−[relevance_score from 0 to 10]
Agent 1: [human/bot]
Dialog 1: [informational_content/clarification/agent_action/feature_request/other]
Topic 1: [topic]
. . .
User Question N: [question]
Answer N: [answer in markdown]
Relevance Score N: [explanation for the score]−[relevance_score from 0 to 10]
Agent N: [human/bot]
Dialog N: [informational_content/clarification/agent_action/feature_request/other]
Topic N: [topic]
′ ′ ′
Your task is to integrate all relevant Q&A pairs into one single coherent final Q&A pair. If some Q&A pairs are unrelated to main topic of discussion, simply discard them. Don't include phatic expressions or responses that do not convey any meaningful information.
Only include Q&A pairs that have the dialog classified as informational_content. Use the other pairs only for context.
Don't include support bot answers. That is, only include Q&A pairs that are from a human agent. Use the bot pairs only for context.
Make the output general so that they can be useful to other {app_name}customers.
Never ask the customer to contact support in the answer: they are already talking to customer support.
Before starting, summarize the main thread of discussion into a topic.
For each Q&A pair, repeat the original question and answer and add whether it should be included or not in the final answer ([inclusion] should be yes or no) and the reason why.
Finally, provide the final question and answer, which can be as long as it's needed to cover all important points.
Provide the output in the following format:
Topic: [the main topic or thread of discussion you identify in the Q&A pairs]
User Question 1: [question]
Answer 1: [answer in markdown]
Inclusion 1: [explanation for the inclusion]−[inclusion]
. . .
User Question N: [question]
Answer N: [answer in markdown]
Inclusion N: [explanation for the inclusion]−[inclusion]
Final answer:
Number of included Q&A pairs: [number]
Question: [question]
Answer: [answer in markdown]
Now apply those steps to the following Q&A pairs:
′ ′ ′
{extraction}
′ ′ ′
User Question 1: “″”.strip( )

In this specific example of the subsequent prompt, the results can be extracted with the following regular expression (“regex”):
Final answer:\s*Number of included Q&A pairs:\s*(d+)\s*Question:\s*((?:.|\n)*?)\s*Answer:\s*(.*)”

In some embodiments, the single, summarized Q&A pair is stored. In some implementations, the single, summarized Q&A pair is stored in a content management system. For example, the content management system may be utilized to provide an FAQ web page. In some implementations, the single, summarized Q&A pair is stored in a vector database by generating an embedding of the single, summarized Q&A pair (e.g., or a portion thereof, such as the question or the answer of the single, summarized Q&A pairs) using Sentence Bidirectional Encoder Representations from Transformers (“SBERT”). In some embodiments, the single, summarized Q&A pair is only stored responsive to user approval (e.g., following approval by a CSA).

In some embodiments, in response to a query from a customer through a chat interface, semantic search is used to generate an answer based on the semantic similarity of a question in the Q&A pair to the query from the customer. For example, the answer from the Q&A pair can be generated by determining the semantic similarity of embedding of the question of the Q&A pair to an embedding of the query (e.g., based on a dot product of the embeddings). As another example, the answer from the Q&A pair can be generated by determining the semantic similarity of embedding of the answer of the Q&A pair to an embedding of the query (e.g., using Microsoft Machine Reading Comprehension (“MS MARCO”) model as the model is fine-tuned for Q&A asymmetrical search). In some embodiments, historical customer data for the customer inputting the query can be utilized to provide contextual information for the query. For example, the contextual information related to the historical customer data can be encoded into the embedding of the query. In this regard, the semantic search used to generate an answer can based on the semantic similarity of the question and/or answer in the Q&A pair to the query from the customer and/or historical customer data of the customer.

In some embodiments, the semantically similar Q&A pair (e.g., or a portion thereof, such as the answer from the Q&A pair) can be provided to a CSA to assist the CSA used to help craft a reply to the customer through the chat interface. In some embodiments, a chatbot can automatically provide an answer to a customer through the chat interface based on the answer of the semantically similar Q&A pair. In some embodiments, historical customer data for the customer that input the query can be provided to the CSA with the semantically similar Q&A pair. In this regard, the CSA can utilize the historical customer data for the customer and/or the semantically similar Q&A pair to help craft a reply to the customer through the chat interface.

Advantageously, efficiencies of computing and network resource utilization can be enhanced using implementations described herein. In particular, the automated extraction of conversational snippets using a language model provides for a more efficient use of computing and network resources than conventional methods of manually analyzing conversational snippets, editing information, and/or adding information to a knowledge base by a human. The technology described herein decreases the number of computer input/output operations related to manual human analysis of each conversation, drafting, editing and/or adding of information to the knowledge base, thereby decreasing computation costs and decreasing network resource utilization (e.g., higher throughput, lower latency, and decreasing packet generation costs due to fewer packets being sent) when the information is located over a computer network.

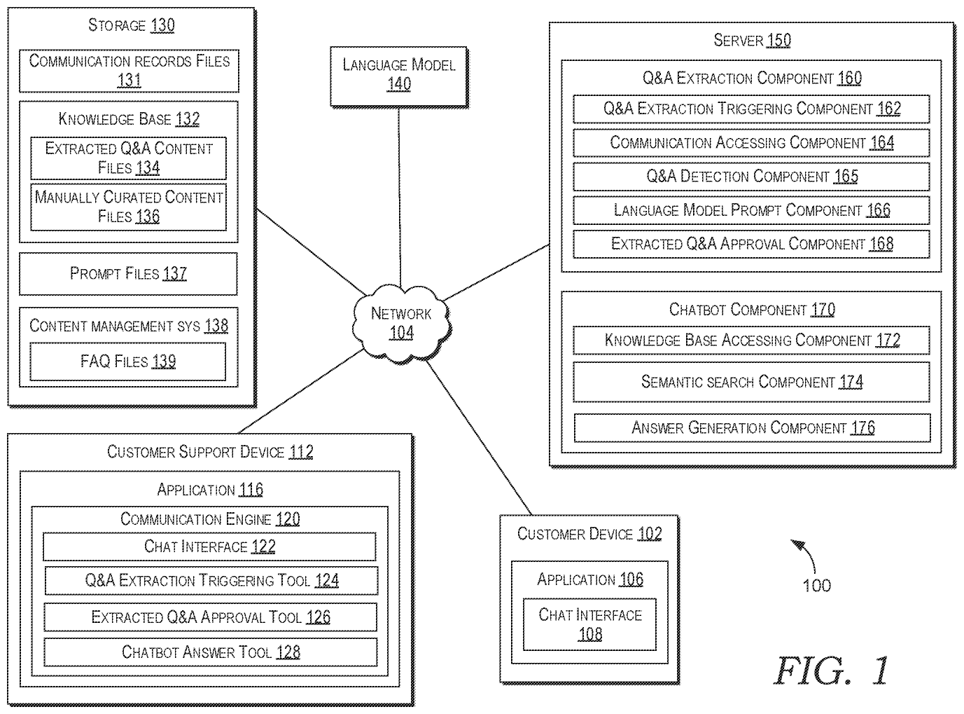

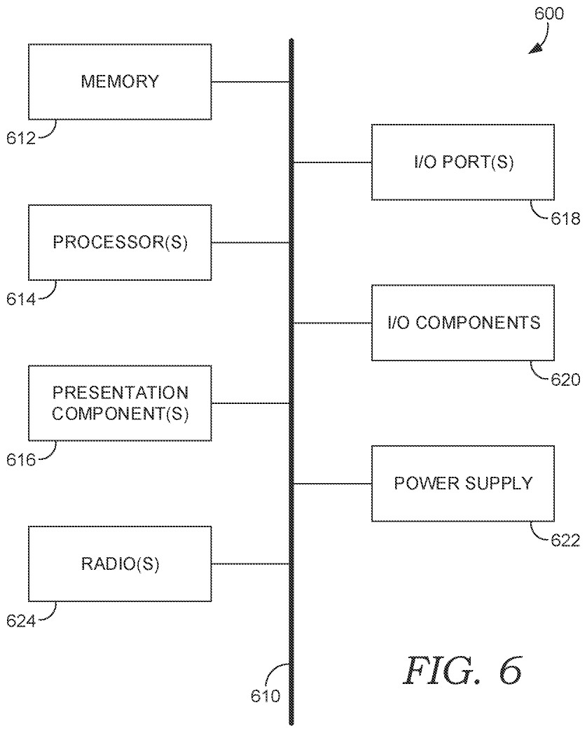

Turning to FIG. 1, a block diagram of example environment 100 suitable for use in implementing embodiments of the disclosure is shown. Generally, environment 100 is suitable for using a language model to extract conversational snippets, such as by extracting conversational snippets corresponding to Q&A pairs from conversations between a customer (e.g., or potential customer or any individual providing questions to customer support) and a CSA (e.g., or any support personnel), and storing the conversational snippets in a help center database and/or a vector database so that a chatbot or CSA can utilize the Q&A snippets to provide automated customer support. Environment 100 includes customer device 102, customer support device 112, and server 150. In various embodiments, customer device 102, customer support device 112, and/or server 150 are any kind of computing device, such as computing device 600 described below with reference to FIG. 6. Examples of computing devices include a personal computer (PC), a laptop computer, a mobile or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, some combination thereof, or any other suitable computer device.

In various implementations, the components of environment 100 include computer storage media that stores information including data, data structures, computer instructions (e.g., software program instructions, routines, or services), and/or models (e.g., machine learning models) used in some embodiments of the technologies described herein. For example, in some implementations, customer device 102, customer support device 112, language model 140, server 150, and/or storage 130 may comprise one or more data stores (or computer data memory). Further, although customer device 102, customer support device 112, server 150, language model 140, and storage 130 are each depicted as a single component in FIG. 1, in some embodiments, customer device 102, customer support device 112, server 150, language model 140, and/or storage 130 are implemented using any number of data stores, and/or are implemented using cloud storage.

The components of environment 100 communicate with each other via a network 104. In some embodiments, network 104 includes one or more local area networks (LANs), wide area networks (WANs), and/or other networks. Such networking environments are commonplace in offices, enterprise-wide computer networks, intranets, and the Internet.

In the example illustrated in FIG. 1, customer device 102 includes application 106 with chat interface 108, customer support device 112 includes application 116 with communication engine 120, and server 150 includes Q&A extraction component 160 and chatbot component 170. In various embodiments, chat interface 108, communication engine 120 with chat interface 122, Q&A extraction component 160, chatbot component 170, and/or any of the elements illustrated in FIG. 1 are incorporated, or integrated, into an application(s) (e.g., a corresponding application on customer device 102, customer support device 112, and/or server 150, respectively), or an add-on(s) or plug-in(s) to an application(s). In some embodiments, the application(s) 106 and/or 116 is any application capable of facilitating a chat between a customer and a CSA, such as a stand-alone application, a mobile application, a web application, and/or the like. In some implementations, the application(s) 106 and/or 116 comprises a web application, for example, that may be accessible through a web browser, hosted at least partially server-side, and/or the like.

In various embodiments, the functionality described herein is allocated across any number of devices. In some embodiments, application(s) 106 and/or 116 are hosted at least partially server-side, such that chat interface 108, communication engine 120 with chat interface 122, Q&A extraction component 160, chatbot component 170, and/or any of the elements illustrated in FIG. 1 coordinate (e.g., via network 104) to perform the functionality described herein. In another example, communication engine 120 with chat interface 122, Q&A extraction component 160, chatbot component 170, and/or any of the elements illustrated in FIG. 1 (or some portion thereof) are integrated into a common application executable on a single device. Although some embodiments are described with respect to an application(s), in some embodiments, any of the functionality described herein is additionally or alternatively integrated into an operating system (e.g., as a service), a server (e.g., a remote server), a distributed computing environment (e.g., as a cloud service), and/or otherwise. These are just examples, and any suitable allocation of functionality among these or other devices may be implemented within the scope of the present disclosure.

An example workflow of the configuration illustrated in FIG. 1 includes customer device 102, such as a desktop, laptop, or mobile device such as a tablet or smart phone, and application 106 provides one or more user interfaces. A customer accesses application 106, such as a web browser or mobile application, and navigates to a website or application of a business. The customer navigates to a chat interface 108 through application 106 allowing the customer to chat with customer support of the business. In this regard, the customer is able to communicate with the business, such as through a chatbot associated with the business via chatbot component 170 and/or a CSA of the business (e.g., where the CSA utilizes a corresponding chat interface 122 of the customer support device 112).

Customer support device 112 is a desktop, laptop, or mobile device such as a tablet or smart phone, and application 116 provides one or more user interfaces. In some embodiments, an end user, such as a CSA of the business, chats, or accesses a chat (e.g., a conversation with the customer), with a customer through chat interface 122 of communication engine 120. Additionally or alternatively, a chatbot via chatbot component 170 chats, or accesses a chat (e.g., a conversation with the customer), with a customer through chat interface 122 of communication engine 120.

In some embodiments, Q&A extraction component 160 facilitates using a language model 140 to extract conversational snippets from conversations between a customer and a CSA. Data regarding the conversations can be stored in any suitable storage location, such as storage 130, customer support device 112, server 150, some combination thereof, and/or other locations as communication records files 131.

Q&A extraction triggering component 162 triggers extraction of conversational snippets from conversations between a customer and a CSA. Communication accessing component 164 accesses a conversation from a communication record (e.g., communication records files 131). For example, the communication record of communication records files 131 may comprise a chat log, chat transcript, meeting transcript, email, or other communication between a customer and a CSA. For example, a customer initiates a chat with a CSA through a chat interface 108 of application 106 executing on customer device 102. During the chat, the customer asks the CSA a series of questions and the CSA provides answers to each question through chat interface 122 of application 116 executing on customer support device 112 before the chat is ended. After the chat ends, the chat is stored (e.g., communication records files 131) so that the chat can be accessed in order to extract each question and corresponding answer (“Q&A pairs”) from the chat in a subsequent step. In some embodiments, the conversation can be accessed from the communication record by communication accessing component 164 during the conversation (e.g., chat) between the customer and the CSA in order to extract Q&A pairs from the conversation during the conversation.

In some embodiments, Q&A detection component 165 detects Q&A pairs from the communication record. For example, Q&A detection component 165 analyzes the conversation to determine that the conversation has qualifying Q&A pairs or if the conversation meets certain criteria. The communications from the customer and corresponding responses from the CSA and/or detected Q&A pairs may be indexed in the communication record by Q&A detection component 165, or a portion of the conversation comprising the Q&A pair may be extracted from the communication record by Q&A detection component 165. In one implementation, Q&A detection component 165 indexes detected Q&A pairs using a logical index wherein a corresponding pointer (or pointers) is used by Q&A detection component 165 to reference the portion of the conversation that includes the Q&A pair. Data regarding the detected and/or indexed Q&A pairs can be stored in any suitable storage location, such as storage 130, customer support device 112, server 150, some combination thereof, and/or other locations.

In some implementations, Q&A extraction triggering component 162 implements live extraction to extract Q&A pairs during a conversation between a customer and a CSA and/or immediately after a conversation ends between a customer and a CSA. In these implementations, criteria, or any combination of criteria, are utilized by Q&A extraction triggering component 162 to determine whether to extract a Q&A pair(s). In one example, the criteria can be implemented by Q&A extraction triggering component 162 to only trigger extraction based on a threshold length of message from the CSA. For example, the CSA's message needs to be at least 10 characters long. In another example, the criteria can be implemented by Q&A extraction triggering component 162 to only trigger extraction based on a threshold dissimilarity between answers and passages from the help center database (e.g., extracted Q&A content files 134 and/or manually curated content files 136 of knowledge base 132 and/or FAQ files 139 of content management system 138). For example, if an answer is at least 60% similar to a help center passage using the partial Levenshtein similarity, no extraction is triggered by Q&A extraction triggering component 162. In another example, the criteria can be implemented by Q&A extraction triggering component 162 to only trigger extraction for certain conversations based on a probability model. For example, the probability of the extraction of being triggered by Q&A extraction triggering component 162 is given by the following probability model:

Threshold=Max(0.01,Min(0.99,Agent message character length/600))

If Uniform[0,1]>Threshold,run extraction,else do nothing

In other implementations, Q&A extraction triggering component 162 implements batch processing of communication records (e.g., after a certain number of conversations has occurred). In these implementations, criteria, or any combination of criteria, may be used by Q&A extraction triggering component 162 to determine which conversations should be included in the batch processing. In one example, the criteria can be implemented by Q&A extraction triggering component 162 to include a start date filter. For example, communication records can be batch processed by Q&A extraction triggering component 162 to trigger extractions for conversations from a certain date. In another example, the criteria can be implemented by Q&A extraction triggering component 162 to batch process communication records by filtering conversations which are closed, snoozed, and/or open. In another example, the criteria can be implemented by Q&A extraction triggering component 162 to batch process communication records by removing duplicate communication records and/or Q&A pairs in batch extraction. For example, the criteria can be implemented by Q&A extraction triggering component 162 to batch process communication records to remove duplicate Q&A pairs by using semantic or string similarity to find similar Q&A pairs and preserve just one. In another example, the criteria can be implemented by Q&A extraction triggering component 162 to batch process communication records limiting the number of extractions, for example, based on the probability model:

Threshold=Max(0.01,Min(0.99,Agent message character length/600))

If Uniform[0,1]>Threshold,run extraction,else do nothing

In some embodiments, language model prompt component 166 generates an input prompt with the indexed conversation (e.g., or portion thereof) for a language model 140 that is trained to generate a natural language output based on an input prompt. In this regard, the input prompt generated by language model prompt component 166 includes a request to the language model 140 (e.g., an LLM such as GPT4) to extract Q&A pairs from the portion of the conversation and to generate a single, summarized Q&A pair based on the Q&A pairs extracted from the conversation (e.g., communication records files 131). For example, the conversation included with the input prompt by language model prompt component 166 to the language model 140 may be represented in a string format and can include:
Bot: [bot_message1]
User: [user_message1]
Agent: [agent_message1]
User: [user_message2]
Agent: [agent_message2]
. . .

As can be understood, “User” represents the customer followed by the customer's corresponding message(s), “Agent” represents the CSA followed by the CSA's corresponding message(s), and “Bot” represents any automated workflow or chatbot that interacts with the user before reaching the CSA followed by the bot's corresponding message(s).

In some implementations, the conversation provided to the language model 140 by language model prompt component 166 is limited to a previous number of characters to prevent context overflow. For example, with respect to GPT4, the context window is 8k tokens, where English words are represented on average with 1.3 tokens. The context window also includes instructions, examples, and the completions, so the conversation needs to occupy at most a fraction of the content window. In this example, the conversation provided to the language model 140 by language model prompt component 166 can be limited to its previous 5000 characters to prevent context overflow.

In some embodiments, a plurality of prompts are provided to the language model 140 by language model prompt component 166 in order to extract Q&A pairs from the portion of the conversation record and to generate a single, summarized Q&A pair based on the Q&A pairs extracted from the conversation record. For example, an initial prompt is provided by language model prompt component 166 to the language model 140 including at least a portion of the conversation containing the Q&A pairs and a request to extract the Q&A pair(s). The initial prompt (and/or a subsequent prompt) provided by language model prompt component 166 can include a request to tag each Q&A pair of the conversation with contextual metadata corresponding to each of the Q&A pairs. A subsequent prompt (and/or the initial prompt) provided by language model prompt component 166 can include a request to filter irrelevant Q&A pairs of the conversation based on the metadata of each Q&A pair (e.g., classify whether the each of the Q&A pairs should be utilized to generate the single, summarized Q&A pair). A subsequent prompt from the initial prompt provided by language model prompt component 166 can include a request to generate a single, summarized Q&A pair based on the remaining Q&A pairs (e.g., after filtering) extracted from the conversation.

In some embodiments, the input prompt, such as a single input prompt or a prompt from a plurality of prompts, provided by language model prompt component 166 to the language model 140 can include additional instructions for the extraction of the Q&A pairs. In one example, the additional instructions provided by language model prompt component 166 to the language model 140 for the extraction of the Q&A pairs can include instructions to preserve links or URLs if links or URLs are relevant to the answer. In another example, the additional instructions provided by language model prompt component 166 to the language model 140 for the extraction of the Q&A pairs can include instructions to remove phatic expressions (e.g., expressions that convey only social information, such as “hello”, “thank you”, “got it”, and/or “you're welcome”). In another example, the additional instructions provided by language model prompt component 166 to the language model 140 for the extraction of the Q&A pairs can include instructions to remove personal information, such as PII, from the Q&A pairs. In another example, the additional instructions provided by language model prompt component 166 to the language model 140 for the extraction of the Q&A pairs can include instructions to only extract Q&A pairs that are useful to other customers.

In some embodiments, the input prompt, such as a single input prompt or a prompt from a plurality of prompts, provided by language model prompt component 166 to the language model 140 can include instructions to tag each Q&A pair of the conversation with contextual metadata corresponding to the Q&A pair. For example, the language model 140 can tag (or otherwise associate) each Q&A pair with contextual metadata corresponding to who provided the textual snippet, the topic of the Q&A pairs, the relevance score to other customers, and/or the type of dialog classification for the Q&A. In some embodiments, the index is tagged or otherwise associated with the contextual metadata by language model 140. Examples of contextual metadata include: (1) contextual metadata corresponding to whether the question was answered by a human (e.g., a CSA) or a bot (e.g., the chatbot); (2) contextual metadata corresponding to the topic of the Q&A pair; (3) contextual metadata corresponding to a score indicating the relevance of the Q&A pair to other customers; and/or (4) contextual metadata corresponding to a dialog classification corresponding to a category of the type of dialogue. For example, categories of the type of dialogue can include: (a) informational content where an answer in the Q&A pair is directed to general information, knowledge and/or instructions; (b) a clarification where an answer in the Q&A pair is a request for clarification from the user; (c) a CSA action where an answer in the Q&A pair required the CSA to take some action on the background of the conversation; (d) a feature request where an answer in the Q&A pair is directed to future product improvements or feature requests; and/or (e) other categories or a category for an answer in the Q&A pair does not fit into the previous specified types of dialogue.

A specific example of an initial prompt provided by language model prompt component 166 to a language model 140 with a request to extract the Q&A pair(s) and tag each Q&A pair of the conversation with contextual metadata corresponding to each of the Q&A pairs is as follows:
EXTRACT_SYSTEM_PROMPT=“″”
You're an expert customer support AI working for {app_name}. You can differentiate between informational and phatic content. You're a master at identifying personal information and PII. You always provide the answers in markdown format. Your main task is extracting questions and answers pairs from a conversation. Those Q&A pairs will be used to create a help center article that will be used by a chatbot to solve customer issues.
“″”.strip( )
EXTRACT_HUMAN_MESSAGE1=“″”
Given a conversation history between a user (User) and a customer support agent (Agent), extract all the questions asked by the user and all the answers provided by the customer support agent that have informational content. Don't include phatic expressions or responses that do not convey any meaningful information. Remove any personal or PII information, but keep relevant URLs and links. Make the questions and answers general so that they can be useful to other {app_name}customers. Never ask the customer to contact support in the answer: they are already talking to customer support. For each Q&A pair, provide a relevancy score from 0 to 10, where 0 means irrelevant for other users and 10 means relevant for any potential user. Explain the reasoning before providing the score. For each Q&A pair, classify the agent into “human” or “bot”.
For each Q&A pair, provide a dialog classification. The dialog should be one of the following categories:
   informational_content: an answer that contains general information, knowledge or instructions
   clarification: an answer that requires clarification from the user
   agent_action: an answer that required the agent to take some action on the background
   feature_request: an answer talking about future product improvements or feature requests
   other: whatever doesn't fit the previous options
For each Q&A pair, provide a topic classification. Come up with a topic that best represents the pair.
Provide the output in the following format:
User Question 1: [question] Answer 1: [answer in markdown]
Relevance Score 1: [explanation for the score]−[relevance_score] Agent 1: [human/bot]
Dialog 1: [informational_content/clarification/agent_action/feature_request/other]
Topic 1: [topic]
User Question 2: [question] Answer 2: [answer in markdown]
Relevance Score 2: [explanation for the score]−[relevance_score] Agent 2: [human/bot]
Dialog 2: [informational_content/clarification/agent_action/feature_request/other]
Topic 2: [topic]
. . .
Here is an example of conversation history:
′ ′ ′
User: Hello, I'm having trouble logging into my account.
Agent: Hi there, Brad!I'm sorry to hear that. Are you getting any error messages?User: Yes, it says my password is incorrect.
Agent: In that case, Brad, you can reset your password using the ““Forgot Password”” option on the login page. This will send an email with instructions to your registered email address. User: Thanks!I tried that, but I haven't received the email yet.
Agent: Please check your spam or junk folder, as sometimes the email can land there. If you still can't find it, nlet me know and I'll assist you further, Brad.
User: I found it in my spam folder. Thanks for the help!
Agent: You're welcome, Brad! If you face any more difficulties, let me know. Have a great day, bye!
′ ′ ′
Here is the expected output:
“″”.strip( )
EXTRACT_ASSISTANT_MESSAGE1=“″”
User Question 1: What should I do if I have trouble logging into my account?
Agent Answer 1: Check if you are getting any error messages. The error messages can help identify the problem.
Relevance Score 1: Relevant for all users that might be having problems logging in—9
Agent 1: human
Dialog 1: informational_content Topic 1: Account login
User Question 2: What should I do if my password is incorrect?
Agent Answer 2: You can reset your password using the ““Forgot Password”” option on the login page. This will send an email with instructions to your registered email address.
Relevance Score 2: Relevant for users that are inputting the wrong password, which seems rarer than logging in issues—7
Agent 2: human
Dialog 2: informational_content
Topic 2: Account login
User Question 3: What if I haven't received the password reset email?
Agent Answer 3: Check your spam or junk folder, as sometimes the email can land there. Relevance Score 3: Relevant for users that couldn't find the password reset email, even rarer—6
Agent 3: human
Dialog 3: informational_content Topic 3: Account login “″”.strip( )
EXTRACT_HUMAN_MESSAGE2=“″”
Here is another example of conversation history:
′ ′ ′
User: Hello, I need help!
Agent: Hey, how can I help you today?
′ ′ ′
Here is the expected output:
“″”.strip( )
EXTRACT_ASSISTANT_MESSAGE2=“″”
Nothing to extract “″”.strip( )
EXTRACT_HUMAN_MESSAGE3=“″”
Extract only the questions and answers with informational content answered by a human agent, remove any PII or personal information (except URLs and links), and generalize the content for other customers. Format the answers in markdown. If there are no questions and answers to extract, simply say “Nothing to extract”.
′ ′ ′
{conversation}
′ ′ ′“″”.strip( )

In some embodiments, the input prompt, such as a single input prompt or a prompt from a plurality of prompts, provided by language model prompt component 166 to the language model 140 can include instructions to filter irrelevant Q&A pairs of the conversation based on the contextual metadata of each Q&A pair. For example, each of the Q&A pairs of the conversation can be classified by language model 140 as to whether each Q&A should be included in the final Q&A, such as based on the relevance of the Q&A to the conversation and any of the contextual metadata tags. In one example, the instructions provided by language model prompt component 166 to the language model 140 may instruct the language model 140 to filter out Q&A pairs with an answer from a bot (e.g., a chatbot) so that only Q&A pairs with human-generated answers remain (e.g., answers generated by the CSA). In another example, the instructions provided by language model prompt component 166 to the language model 140 may instruct the language model 140 to filter out Q&A pairs with answers with certain dialog classifications (e.g., filter out categories of the type of dialogue corresponding to clarification, CSA action, feature request or other). In this regard, only Q&A pairs with answers classified into a dialogue classification where the answer in the Q&A pair includes informational content (e.g., directed to general information, knowledge and/or instructions) remain. In another example, the instructions provided by language model prompt component 166 to the language model 140 may instruct the language model 140 to filter out Q&A pairs with answers that are irrelevant to the main topic of the conversation so that only Q&A pairs relevant to the main topic of the conversation remain. In some embodiments, the instructions provided by language model prompt component 166 to filter irrelevant Q&A pairs of the conversation based on the metadata of each Q&A pair are included in a second prompt to the language model 140.

In some embodiments, the input prompt, such as a single input prompt or a prompt from a plurality of prompts, provided by language model prompt component 166 to the language model 140 can include instructions to generate a single, summarized Q&A pair for the remaining Q&A pairs (e.g., after filtering). In one example, the instructions provided by language model prompt component 166 to the language model 140 may instruct the language model 140 to generate the single, summarized Q&A pair while preserving links (e.g., URLs) if the links are relevant to the answer of the single, summarized Q&A pair. In another example, the instructions provided by language model prompt component 166 to the language model 140 may instruct the language model 140 to generate the single, summarized Q&A pair while removing phatic expressions (e.g., expressions that convey only social information, such as “hello”, “thank you”, “got it”, and/or “you're welcome”) from the single, summarized Q&A pair. In another example, the instructions provided by language model prompt component 166 to the language model 140 may instruct the language model 140 to generate the single, summarized Q&A pair so that the single, summarized Q&A pair is useful to other customers. In another example, the instructions provided by language model prompt component 166 to the language model 140 may instruct the language model 140 to generate the single, summarized Q&A pair and remove any personal information (e.g., PII) from the single, summarized Q&A pair. In some embodiments, the instructions provided by language model prompt component 166 to generate a single, summarized Q&A pair for the remaining Q&A pairs (e.g., after filtering) are included in the second prompt to the language model 140.

A specific example of a subsequent prompt (e.g., a second prompt), following the specific example of the initial prompt above, provided by language model prompt component 166 to a language model 140 with a request to filter irrelevant Q&A pairs of the conversation based on the metadata of each Q&A pair and generate a single, summarized Q&A pair based on the remaining Q&A pairs (e.g., after filtering) extracted from the conversation is as follows:
SUMMARIZE_SYSTEM_PROMPT=“″”
You're an expert customer support AI working for {app_name}. You can integrate multiple customer issues into one help center article. “″”.strip( )
SUMMARIZE_HUMAN_MESSAGE=“″”
You will be given a list of extracted questions and answers (Q&A) pairs from a conversation between a user and a customer support agent with this format:
′ ′ ′
User Question 1: [question]
Answer 1: [answer in markdown]
Relevance Score 1: [explanation for the score]−[relevance_score from 0 to 10]
Agent 1: [human/bot]
Dialog 1: [informational_content/clarification/agent_action/feature_request/other]
Topic 1: [topic]
. . .
User Question N: [question]
Answer N: [answer in markdown]
Relevance Score N: [explanation for the score]−[relevance_score from 0 to 10]
Agent N: [human/bot]
Dialog N: [informational_content/clarification/agent_action/feature_request/other]
Topic N: [topic]
′ ′ ′
Your task is to integrate all relevant Q&A pairs into one single coherent final Q&A pair. If some Q&A pairs are unrelated to main topic of discussion, simply discard them. Don't include phatic expressions or responses that do not convey any meaningful information.
Only include Q&A pairs that have the dialog classified as informational_content. Use the other pairs only for context.
Don't include support bot answers. That is, only include Q&A pairs that are from a human agent. Use the bot pairs only for context.
Make the output general so that they can be useful to other {app_name}customers.
Never ask the customer to contact support in the answer: they are already talking to customer support.
Before starting, summarize the main thread of discussion into a topic.
For each Q&A pair, repeat the original question and answer and add whether it should be included or not in the final answer ([inclusion] should be yes or no) and the reason why.
Finally, provide the final question and answer, which can be as long as it's needed to cover all important points.
Provide the output in the following format:
Topic: [the main topic or thread of discussion you identify in the Q&A pairs]
User Question 1: [question]
Answer 1: [answer in markdown]
Inclusion 1: [explanation for the inclusion]−[inclusion]
. . .
User Question N: [question]
Answer N: [answer in markdown]
Inclusion N: [explanation for the inclusion]−[inclusion]
Final answer:
Number of included Q&A pairs: [number]
Question: [question]
Answer: [answer in markdown]
Now apply those steps to the following Q&A pairs:
′ ′ ′
{extraction}
′ ′ ′
User Question 1:“″”.strip( )

In this specific example of the subsequent prompt provided by language model prompt component 166, the results can be extracted with the following regex by Q&A extraction component 160:
Final answer:\s*Number of included Q&A pairs:\s*(\d+)\s*Question:\s*((?:.|\n)*?)\s*Answer:\s*(.*)”

Data regarding the prompts utilized and/or generated by language model prompt component 166 can be stored in any suitable storage location, such as storage 130, customer support device 112, server 150, some combination thereof, and/or other locations as prompt files 137.

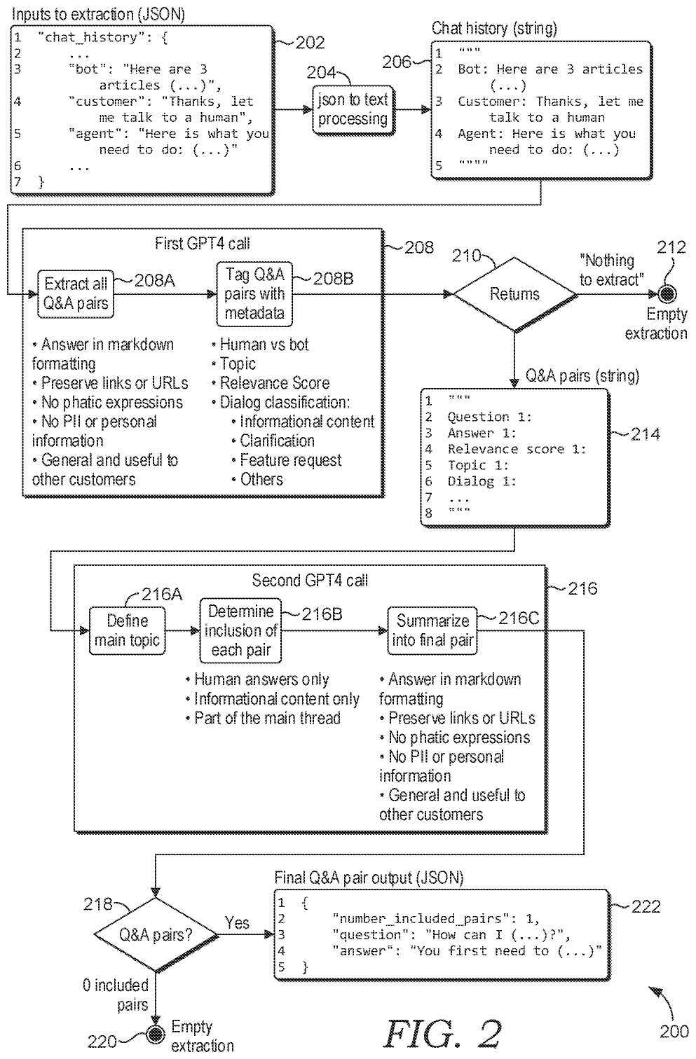

An example diagram 200 of a model implemented to extract and summarize a conversational snippet from a communication record is shown in FIG. 2. As shown in FIG. 2, the input 202 corresponding to the chat history between a customer and a bot and CSA is extracted in JavaScript Object Notation (“JSON”) format. The input is provided to JSON to text processing 204 to generate a string 206 corresponding to the chat history. The string 206 is provided to the language model, such as GPT4, along with instructions in the first call 208 to the language model.

Instructions 208A of the first call 208 to the language model include a request to extract all Q&A pairs from the chat history string 206. Further, instructions 208A of the first call 208 include instructions to the language model to (1) provide the extracted Q&A pairs in markdown formatting; (2) preserve links or URLs if they make sense with respect to the answer of the Q&A pair; (3) remove phatic expressions from the Q&A pairs; (4) remove PI or personal information in the output; and (5) only include Q&A pairs that are general and useful to other customers.

The first call 208 to the language model also includes instructions 208B. Instructions 208B of the first call 208 to the language model include a request to tag the extracted Q&A pairs with contextual metadata. The contextual metadata identifies (1) whether each Q&A pair corresponds to a human or a bot; (2) the topic of each Q&A pair; (3) a score corresponding to the relevance of each Q&A pair to other customers; and (4) a dialogue classification for each of the Q&A pairs where each of the Q&A pairs are classified as (a) informational content where an answer from the CSA contains general information, knowledge or instructions; (b) clarification where an answer from the CSA requires clarification from the user; (c) agent action where an answer from the CSA required the CSA to take some action on the background; (d) feature request where an answer from the CSA discusses future product improvements or feature requests; and (e) other where an answer from the CSA does not correspond to the previous dialogue classifications.

The language model generates a response 210. If the response 210 indicates that there is nothing to extract, an empty extraction 212 is indicated. If the response 210 indicates that the extraction was successful, the extracted Q&A pairs are output as a string 214. The string 214 is provided to the language model, such as GPT4, along with instructions in the second call 216 to the language model.

Instructions 216A of the second call 216 to the language model include a request to define the main top of the extracted Q&A pairs of string 214. Instructions 216B of the second call 216 to the language model include a request to determine whether to include each of the extracted Q&A pairs (e.g., filter out irrelevant Q&A pairs) by (1) including only human answers (e.g., answers from the CSA); (2) including only answers with a dialogue classification corresponding to informational content; and (3) including only answers relevant to the main topic identified by instructions 216A. Instructions 216C of the second call 216 to the language model include a request to summarize the Q&A pairs identified by instructions 216B and (1) provide the extracted Q&A pairs in markdown formatting; (2) preserve links or URLs if they make sense with respect to the answer of the Q&A pair; (3) remove phatic expressions from the Q&A pairs; (4) remove PI or personal information in the output; and (5) only include Q&A pairs that are general and useful to other customers.

The language model generates a response 218. If the response 218 indicates that there are no Q&A pairs to be included in the response, an empty extraction 220 is indicated. If the response 218 indicates that there are Q&A pairs to be included in the response, the final, summarized Q&A pair is generated by the language model and output as a JSON 222.

Returning to FIG. 1, in some embodiments, the single, summarized Q&A pair generated by the language model is stored in storage 130. In some implementations, the single, summarized Q&A pair is stored in a content management system 138 as FAQ files 139. For example, the content management system 138 may be utilized to provide an FAQ web page from the stored FAQ files 139. In some implementations, the single, summarized Q&A pair is stored in a vector database, such as a vector database of knowledge base 132, by generating an embedding of the single, summarized Q&A pair (e.g., or a portion thereof, such as the question or the answer of the single, summarized Q&A pairs) and storing the embedding in association with the single, summarized Q&A pair in the extracted Q&A content files 134. In some embodiments, the embedding is generated using SBERT. In some embodiments, the single, summarized Q&A pair is only stored responsive to user approval (e.g., following approval by a CSA) provided by extracted Q&A approval component 168.

Data regarding the extracted Q&A pairs can be stored in any suitable storage location, such as storage 130, customer support device 112, server 150, some combination thereof, and/or other locations as extracted Q&A content files 134, and/or FAQ files 139.

In some embodiments, in response to a subsequent query from a customer through a chat interface (e.g., chat interface 108), knowledge base accessing component 172 accesses knowledge base 132. Semantic search is used by semantic search component 174 to identify a semantically similar answer based on the semantic similarity of a question in the Q&A pair to the query from the customer. Answer generation component 176 generates an answer to the query of the customer by providing the answer of the semantically similar Q&A pair and/or providing a summarized answer of the semantically similar Q&A pair (e.g., as summarized by language model 140). In some implementations, the answer from the Q&A pair can be generated by answer generation component 176 after determining the semantic similarity of the embedding of the question of the Q&A pair to an embedding of the query (e.g., based on a dot product of the embeddings) via semantic search component 174. As another example, the answer from the Q&A pair can be generated via answer generation component 176 after determining the semantic similarity of embedding of the answer of the Q&A pair to an embedding of the query (e.g., using MS MARCO model as the model is fine-tuned for Q&A asymmetrical search) via semantic search component 174. In some embodiments, historical customer data for the customer inputting the query can be utilized to provide contextual information for the query. For example, the contextual information related to the historical customer data can be encoded into the embedding of the query by semantic search component 174. In this regard, the semantic search used to generate an answer via answer generation component 176 can based on the semantic similarity of the question and/or answer in the Q&A pair to the query from the customer and/or historical customer data of the customer as determined by semantic search component 174.

In some embodiments, the semantically similar Q&A pair (e.g., or a portion thereof, such as the answer from the Q&A pair) can be provided by answer generation component 176 to a CSA via chatbot answer tool 128 to assist the CSA used to help craft a reply to the customer through the chat interface 122. In some embodiments, a chatbot via chatbot component 170 can automatically provide an answer to a customer through the chat interface 108 based on the answer of the semantically similar Q&A pair. In some embodiments, the answer generated by answer generation component 176 may be further generated based on manually curated content files 136 stored in knowledge base 132. For example, semantic search component 174 may identify manually curated content that is semantically similar to the customer's query and may provide the manually curated content, and/or a summary thereof, in addition to semantically similar Q&A pair(s). In some embodiments, historical customer data for the customer that input the query can be provided to the CSA via chatbot answer tool 128 with the semantically similar Q&A pair. In this regard, the CSA can utilize the historical customer data for the customer and/or the semantically similar Q&A pair to help craft a reply to the customer through the chat interface 122.

Customer data can be stored in any suitable storage location, such as storage 130, customer support device 112, server 150, some combination thereof, and/or other locations. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer.

In an example implementation, communication engine 120 provides interface functionality that allows a user (e.g., a CSA) to chat with a customer, trigger extractions of Q&A pairs, approve Q&A pairs for storage (e.g., in content management system 138 as FAQ files 139 to provide an FAQ web page and/or in knowledge base 132 as extracted Q&A content files 134 with corresponding embeddings for use with semantic search component 174) through interactions with an interface controlled by communication engine 120. Generally, communication engine 120 presents one or more interaction elements that provide various interaction modalities for selecting, navigating, chatting with customers, triggering extraction of conversational snippets and/or approving conversational snippets for storage. In various embodiments, these tools are implemented using code that causes a presentation of a corresponding interaction element(s), and detects and interprets inputs interacting with the interaction element(s).

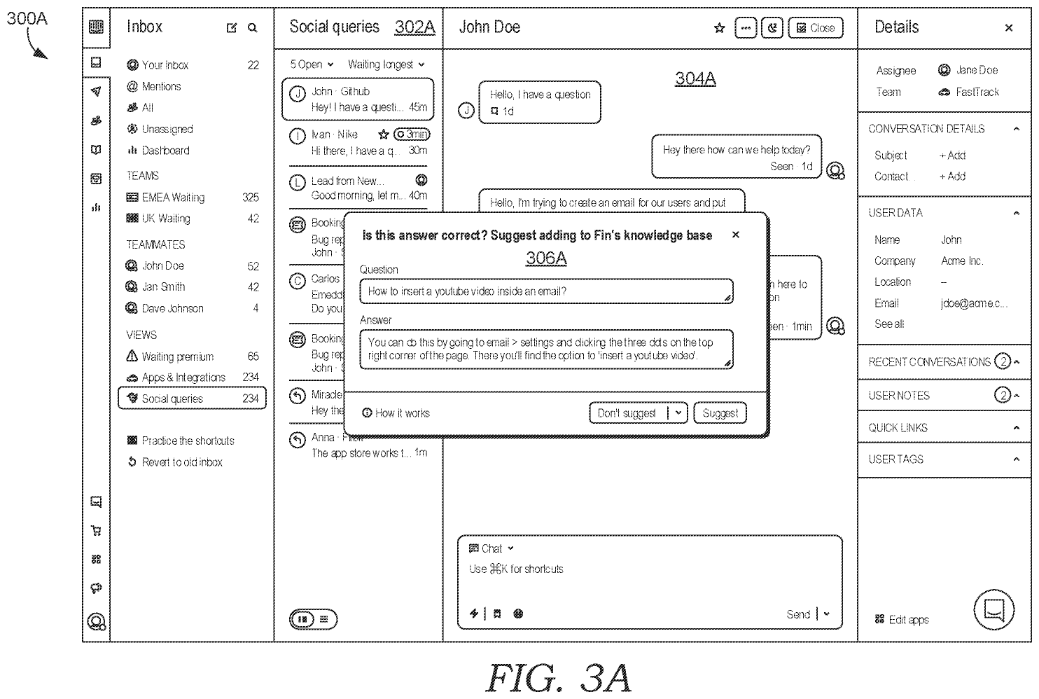

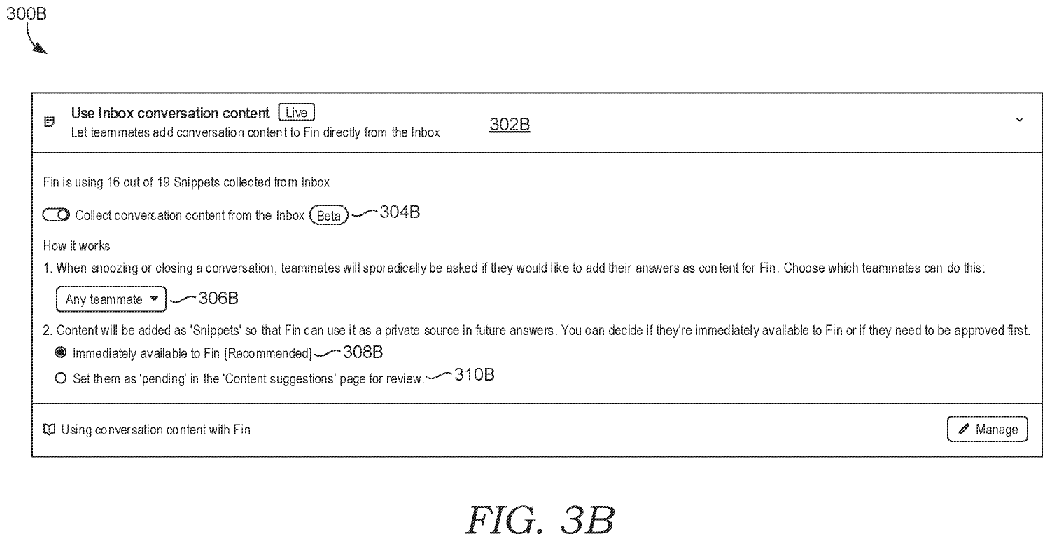

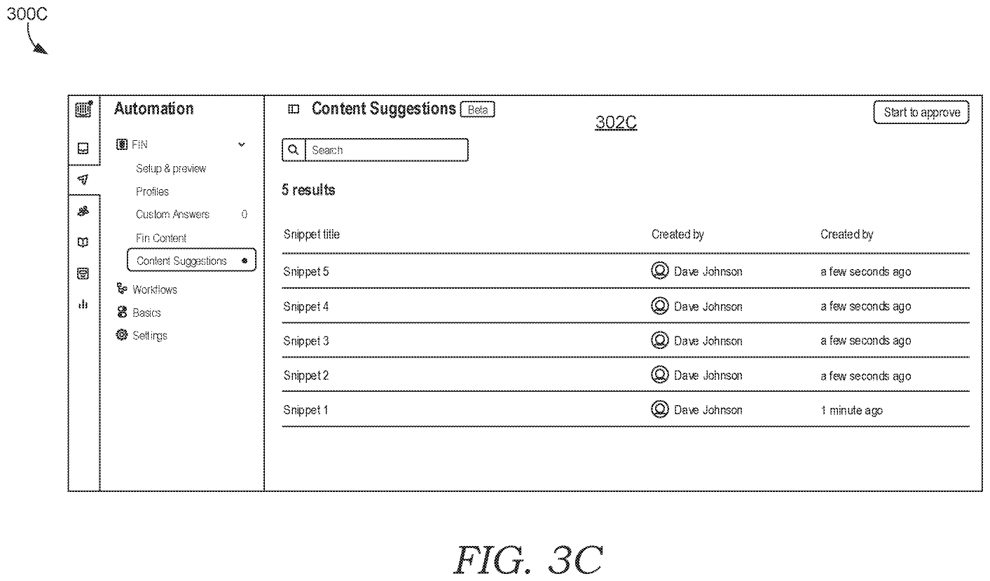

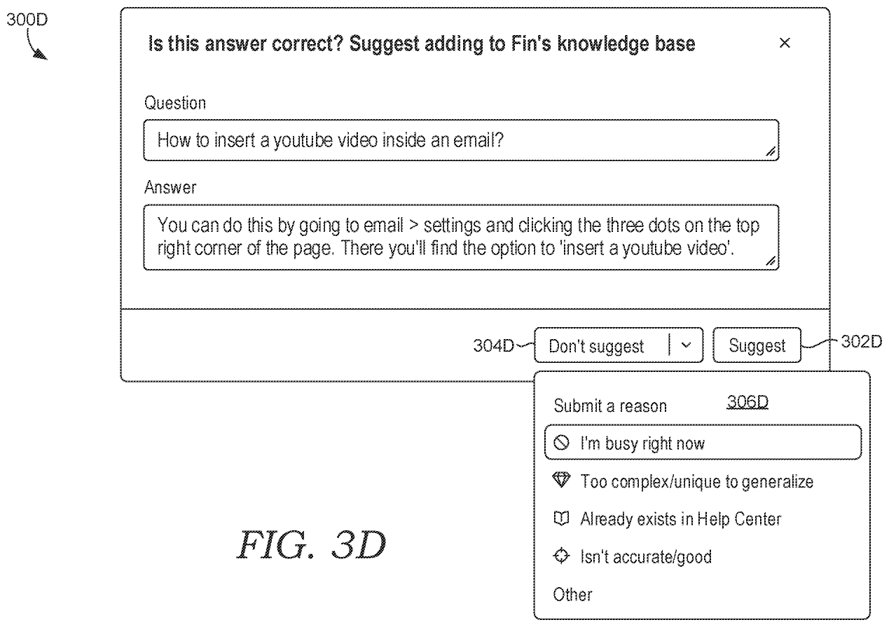

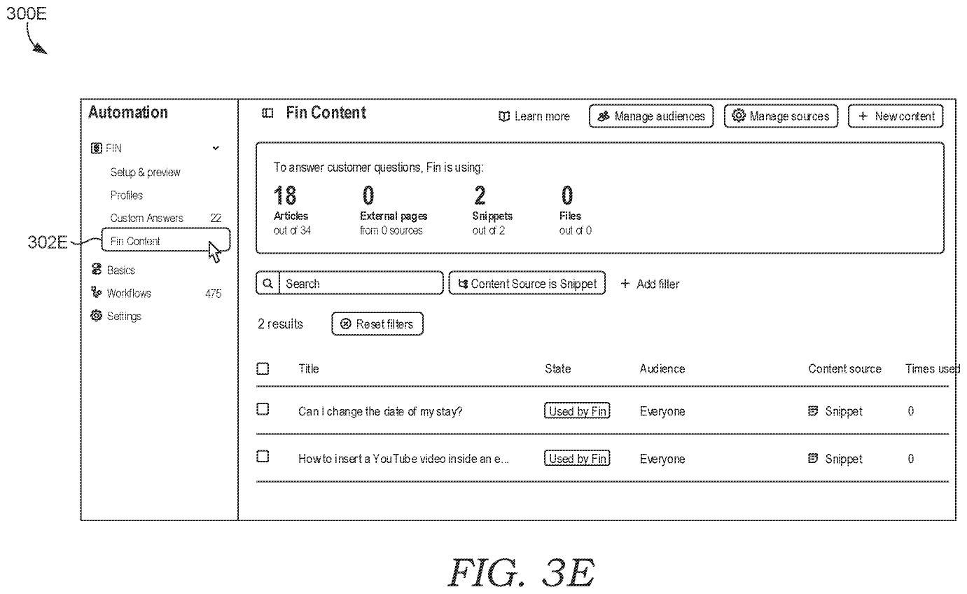

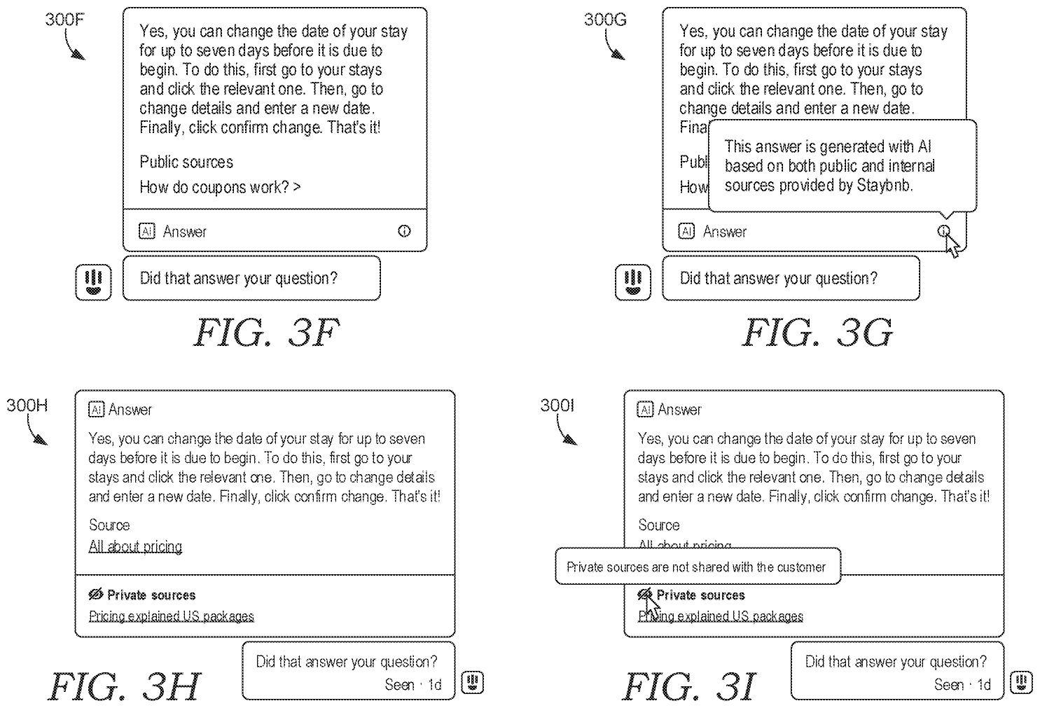

In the example implementation in FIG. 1, communication engine 120 includes chat interface 122 that provides an interface to allow the CSA (and/or chatbot via chatbot component 170) to communicate with a customer (e.g., via chat interface 108 of the customer device 102). Examples of a chat interface displayed to a CSA (e.g., via chat interface 122) are shown in FIGS. 3H and 31. Examples of a chat interface displayed to a customer (e.g., via chat interface 108 of the customer device 102) are shown in FIGS. 3F and 3G. Communication engine 120 includes Q&A extraction triggering tool 124 that provides an interface to allow the CSA to select when to trigger extraction of conversational snippets from conversations with customers. An example of an interface displayed to a CSA (e.g., via Q&A extraction triggering tool 124) to select when to trigger extraction of conversational snippets from conversations with customers is shown in FIG. 3B. Communication engine 120 includes extracted Q&A approval tool 126 that provides an interface to approve conversational snippets for storage (e.g., as FAQ files 139 and/or extracted Q&A content files 134). Examples of interfaces displayed to a CSA (e.g., via extracted Q&A approval tool 126) to approve conversational snippets for storage are shown in FIGS. 3A, 3C, 3D, and 3E. Communication engine 120 includes chatbot answer tool 128 that provides an interface for a chatbot to suggest answers (e.g., via chatbot component 170) to the CSA to assist the CSA to craft a reply to the customer through the chat interface 122.

FIG. 3A illustrates an example interface 300A for adding a conversational snippet from a communication record to a knowledge base, in accordance with embodiments of the present disclosure. In this example, interface 300A provides a list of chats in chat listing interface 302A. The selected chat in chat listing interface 302A is displayed in chat interface 304A. As can be understood, the suggestion element 306A of the single, summarized Q&A pair corresponding to the extracted conversational snippet from the conversation of chat interface in 304A is displayed to the end user (e.g., the CSA). The end user can then select whether to suggest adding the single, summarized Q&A pair to the knowledge base to store the Q&A pair through suggestion element 306A.

FIG. 3B illustrates an example interface 300B for implementing the extraction of conversational snippets from a communication record, in accordance with embodiments of the present disclosure. In this example, interface 300B indicates that the functionality for the extraction of Q&A pairs is enabled as displayed in element 302B. Selection element 304B allows the user (e.g., the CSA) to select whether to enable the functionality to extract Q&A pairs from stored conversations. Dropdown element 306B allows the user to select whether to enable the functionality for the extraction of Q&A pairs for certain teammates or all teammates. Selection element 308B allows the user to select whether to enable the automatic storing of the single, summarized Q&A pairs extracted from conversations. Selection element 310B allows the user to select whether the single, summarized Q&A pairs extracted from conversations should be set as pending and require approval before storing the single, summarized Q&A pairs.

FIG. 3C illustrates an example interface 300C providing content suggestions corresponding to conversational snippets extracted from communication records, in accordance with embodiments of the present disclosure. In this example, interface 300C provides a list of content suggestions 302C. As can be understood, the user selects selection element 310B of FIG. 3B and must approve the suggested single, summarized Q&A pairs extracted from conversations displayed in content suggestions 302C of FIG. 3C in order to store the Q&A pairs in the knowledge base.

FIG. 3D illustrates an example interface 300D for suggesting or not suggesting the addition the conversational snippets to a knowledge base, in accordance with embodiments of the present disclosure. In this example, interface 300D provides the single, summarized Q&A pair corresponding to the extracted conversational snippet from a conversation. The user can then select via selection element 302D to suggest adding the single, summarized Q&A pair to the knowledge base to store the Q&A pair. The user can select via selection element 304D to not suggest (e.g., dismiss) adding the single, summarized Q&A pair to the knowledge base to not store the Q&A pair. In this regard, selection element 304D provides a dropdown element 306D so that the user can indicate the reason for not suggesting the addition of the single, summarized Q&A pair to the knowledge base. For example, the reasons may include that (1) the agent is busy: (2) the Q&A pairs is too complex; (3) the content already exists in the knowledge base; (4) the suggestion is not accurate; and/or (5) other to provide another reason.

FIG. 3E illustrates an example interface 300E providing a listing of conversational snippets extracted and added to the knowledge base, in accordance with embodiments of the present disclosure. In this example, interface 300E provides a selection element 302E, which, upon selection, provides a display of the single, summarized Q&A pairs extracted from conversations that are stored in the knowledge base.

FIGS. 3F-G illustrates example interfaces 300F and 300G for a customer device of a conversation between a customer and a chatbot where the answer generated by the chatbot utilizes a conversational snippet stored in a knowledge base, in accordance with embodiments of the present disclosure. In this example, interface 300F displays an answer provided to a customer through a customer's chat interface based on a single, summarized Q&A pair extracted from a conversation and stored in the knowledge base that is semantically similar to the customer's query. Interface 300G provides an indication of the source of the answer to the customer. In this regard, the source indicates that the answer was generated based on internal sources instead of providing a link to manually curated content stored in a help center. In some embodiments, the source may indicate a link to the Q&A as stored in an FAQ web page.

FIGS. 3H-I illustrates example interfaces 300H and 300I for a customer support device of a conversation between a customer and a chatbot where the answer generated by the chatbot utilizes a conversational snippet stored in a knowledge base, in accordance with embodiments of the present disclosure. In this example, interface 300H provides an answer provided to a customer through a CSA's chat interface based on a single, summarized Q&A pair extracted from a conversation and stored in the knowledge base that is semantically similar to the customer's query. Interface 300I provides an indication of the source to the CSA. In this regard, the source indicates that the private source was not shared with the customer.

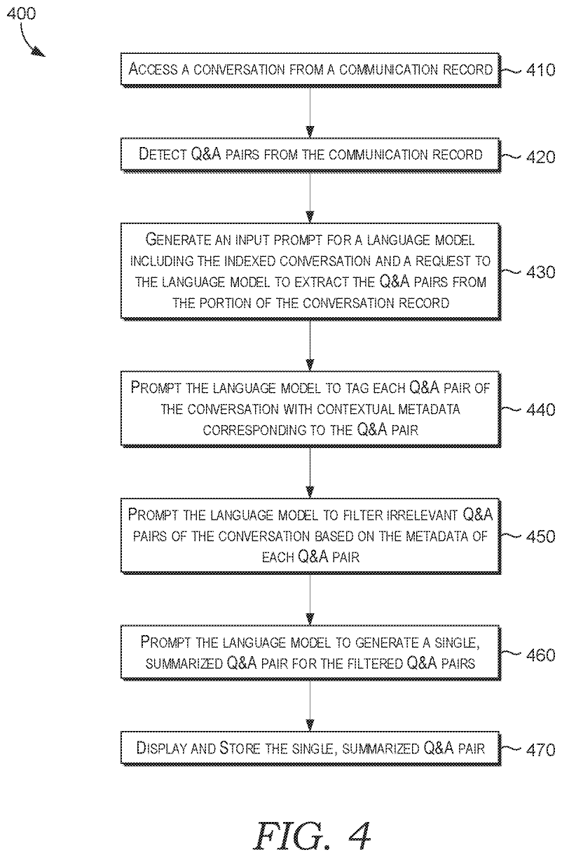

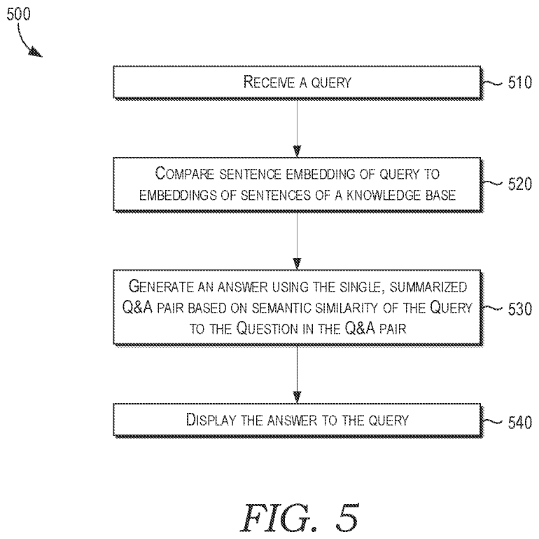

With reference now to FIGS. 4-5, flow diagrams are provided illustrating various methods. Each block of the methods 400-500 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 4 is a flow diagram showing a method 400 for using a language model to extract conversational snippets, in accordance with embodiments of the present disclosure. Initially, at block 410, a conversation from a communication record is accessed. At block 420, Q&A pairs are detected from the communication record. At block 430, an input prompt is generated for a language model including the indexed conversation and a request to the language model to extract the Q&A pairs from the portion of the conversation. At block 440, the language model is prompted to tag each Q&A pair of the conversation with contextual metadata corresponding to the Q&A pair. In some embodiments, the language model is prompted to tag each Q&A pair of the conversation in the initial prompt to the language model. In some embodiments, the language model is prompted to tag each Q&A pair of the conversation in a subsequent prompt to the language model. At block 450, the language model is prompted to filter irrelevant Q&A pairs of the conversation based on the metadata of each Q&A pair. In some embodiments, the language model is prompted to filter irrelevant Q&A pairs in the initial prompt to the language model. In some embodiments, the language model is prompted to filter irrelevant Q&A pairs in a subsequent prompt to the language model. At block 460, the language model is prompted to generate a single, summarized Q&A pair for the filtered Q&A pairs. In some embodiments, the language model is prompted to generate a single, summarized Q&A pair for the filtered Q&A pairs in the initial prompt to the language model. In some embodiments, the language model is prompted to generate a single, summarized Q&A pair for the filtered Q&A pairs in a subsequent prompt to the language model. At block 470, the single, summarized Q&A pair is stored and/or displayed. In some embodiments, the single, summarized Q&A pair is stored responsive to user approval after the single, summarized Q&A pair is displayed to the user. In some embodiments, the single, summarized Q&A pair is stored in a vector database by generating an embedding of the Q&A pair using SBERT. In some embodiments, the single, summarized Q&A pair is stored in a content management system. For example, the content management system may be utilized to provide an FAQ web page.

FIG. 5 is a flow diagram showing a method 500 for generating an answer to a customer query based on a conversation extracted by a language model, in accordance with embodiments of the present disclosure. Initially, at block 510, a query is received from a customer. For example, the query of the customer may be received through a chat interface to a chatbot and/or a CSA. At block 520, a sentence embedding generated from the query is compared to embeddings of sentences of a knowledge base. At block 530, an answer is generated using the single, summarized Q&A pair based on semantic similarity of the query to the question in the Q&A pair. At block 540, the answer to the query is displayed. In some embodiments, a chatbot can automatically provide an answer to a customer based on the semantically similar Q&A pair. In some embodiments, the semantically similar Q&A pair can be provided to a CSA to assist the CSA to help craft a reply to the customer.

Having briefly described an overview of aspects of the technology described herein, an exemplary operating environment in which aspects of the technology described herein may be implemented is described below in order to provide a general context for various aspects of the technology described herein. Referring to the drawings in general, and initially to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein. Neither should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 600. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
accessing a conversation from a communication record between a customer and customer support;
generating one or more prompts for a language model comprising:
at least a portion of the communication record;
a request to the language model to extract each of a set of questions and answer (“Q&A”) pairs from the communication record and to generate a single, summarized Q&A pair based on at least a portion of the set of Q&A pairs;
generating an embedding corresponding to at least a portion of the single, summarized Q&A pair; and
causing storing of the embedding.

2. The computer-implemented method of claim 1, further comprising:
in response to a query through a chat interface from a different customer, using a semantic search to generate an answer to the query based on the similarity of the embedding to a corresponding embedding of the query.

3. The computer-implemented method of claim 1, further comprising:
detecting the set of Q&A pairs from the communication record; and
indexing the set of Q&A pairs using a logical index.

4. The computer-implemented method of claim 1, further comprising:
triggering the generating of the one or more prompts based on at least one of a threshold length of message from the customer support; a threshold dissimilarity between answers from a help center database; and a probability model.

5. The computer-implemented method of claim 1, further comprising:
providing instructions to the language model comprising at least one of instructions to preserve links relevant to each Q&A pair of the set of Q&A pairs, instructions to remove phatic expressions from each Q&A pair of the set of Q&A pairs, instructions to remove personal information from each Q&A pair of the set of Q&A pairs, and instructions to only extract corresponding Q&A pairs of the set of Q&A pairs useful to other customers.

6. The computer-implemented method of claim 1, wherein generating the one or more prompts for the language model further comprises:
generating a first prompt for the language model, the first prompt comprising a first portion of the request corresponding to extracting each of the set of questions and answer (“Q&A”) pairs from the communication record;
generating a second prompt for the language model, the second prompt comprising a second portion of the request corresponding to generating the single, summarized Q&A pair based on at least the portion of the set of Q&A pairs.

7. The computer-implemented method of claim 1, wherein generating the one or more prompts for the language model further comprises:
a further request to the language model to provide contextual metadata corresponding to each Q&A pair of the set of Q&A pairs and to filter irrelevant Q&A pairs from the set of Q&A pairs based on the contextual metadata of each Q&A pair of the set of Q&A pairs.

8. The computer-implemented method of claim 7, wherein the irrelevant Q&A pairs correspond to at least one of answers provided by a bot, irrelevant to a main topic of the communication record, irrelevant to other customers, and a dialog classification.

9. The computer-implemented method of claim 1, wherein the embedding is generated using Sentence Bidirectional Encoder Representations from Transformers (“SBERT”).

10. A non-transitory computer-readable medium storing executable instructions, which when executed by a processing device, cause the processing device to perform operations comprising:
accessing a conversation from a communication record between a customer and customer support;
generating one or more prompts for a language model comprising:
at least a portion of the communication record;
a request to the language model to:
extract each of a set of questions and answer (“Q&A”) pairs from the communication record;
provide contextual metadata corresponding to each Q&A pair of the set of Q&A pairs;
filter irrelevant Q&A pairs from the set of Q&A pairs based on the contextual metadata of each Q&A pair of the set of Q&A pairs; and
generate a single, summarized Q&A pair based on each remaining Q&A pair of the of the set of Q&A pairs;
generating an embedding corresponding to at least a portion of the single, summarized Q&A pair; and
causing storing of the embedding.

11. The media of claim 9, the operations further comprising:
in response to a query through a chat interface from a different customer, using a semantic search to generate an answer to the query based on the similarity of the embedding to a corresponding embedding of the query.

12. The media of claim 9, the operations further comprising:
triggering the generating of the one or more prompts based on at least one of a threshold length of message from the customer support; a threshold dissimilarity between answers and passages from a help center database; and a probability model.

13. The media of claim 9, the operations further comprising:
providing instructions to the language model comprising at least one of instructions to preserve links relevant to each Q&A pair of the set of Q&A pairs, instructions to remove phatic expressions from each Q&A pair of the set of Q&A pairs, instructions to remove personal information from each Q&A pair of the set of Q&A pairs, and instructions to only extract corresponding Q&A pairs of the set of Q&A pairs useful to other customers.

14. The media of claim 9, wherein generating the one or more prompts for the language model further comprises:
generating a first prompt for the language model, the first prompt comprising the at least the portion of the communication record and a first portion of the request corresponding to extracting each of the set of questions and answer (“Q&A”) pairs from the communication record and providing the contextual metadata corresponding to each Q&A pair of the set of Q&A pairs;
generating a second prompt for the language model, the second prompt comprising a second portion of the request corresponding to filtering the irrelevant Q&A pairs from the set of Q&A pairs based on the contextual metadata of each Q&A pair of the set of Q&A pairs and generating the single, summarized Q&A pair based on each remaining Q&A pair of the of the set of Q&A pairs.

15. The media of claim 9, wherein the irrelevant Q&A pairs correspond to at least one of answers provided by a bot, irrelevant to a main topic of the communication record, irrelevant to other customers, and a dialog classification.

16. A computing system comprising:
a processor; and
a non-transitory computer-readable medium having stored thereon instructions that when executed by the processor, cause the processor to perform operations including:
accessing a conversation from a communication record between a customer and customer support;
generating one or more prompts for a language model comprising:
at least a portion of the communication record; and
a request to the language model to extract each of a set of questions and answer (“Q&A”) pairs from the communication record and to generate a representation of at least a portion of the set of Q&A pairs;
generating an embedding corresponding to the representation; and
causing storing of the embedding.

17. The system of claim 16, the instructions that when executed by the processor, cause the processor to perform the operations further including:
in response to a query through a chat interface from a different customer, using a semantic search to generate an answer to the query based on the similarity of the embedding to a corresponding embedding of the query.

18. The system of claim 16, wherein the request to the language model comprises a further request to the language model to provide contextual metadata corresponding to each Q&A pair of the set of Q&A pairs, filter irrelevant Q&A pairs from the set of Q&A pairs based on the contextual metadata of each Q&A pair of the set of Q&A pairs and generate the representation based on each remaining Q&A pair of the of the set of Q&A pairs.

19. The system of claim 16, wherein generating the one or more prompts for the language model further comprises:
generating a first prompt for the language model, the first prompt comprising the at least the portion of the communication record and a first portion of the request corresponding to extracting each of the set of Q&A pairs from the communication record;
generating a second prompt for the language model, the second prompt comprising a second portion of the request corresponding to generating a representation of at least a portion of the set of Q&A pairs.

20. The system of claim 16, wherein the representation corresponds to a single, summarized Q&A pair of the at least the portion of the set of Q&A pairs.
